(19) United States
(12) Patent Application Publication
(10) Pub. No.: US 2013/0277453 A1
(43) Pub. Date: Oct. 24, 2013

(54) FUEL INJECTION VALVE

(71) Applicant: Tatsuo Kobayashi, Susono-shi (JP)

(72) Inventor: Tatsuo Kobayashi, Susono-shi (JP)

(73) Assignee: TOYOTA JIDOSHA KABUSHIKI KAISHA, Toyota-shi, Aichi-ken (JP)

(21) Appl. No.: 13/994,879

(22) PCT Filed: Dec. 20, 2010
(86) PCT No.: PCT/JP2010/072940

§ 371 Date: Jun. 17, 2013

(51) Int. Cl. F02M 55/00

(52) U.S. Cl. CPC F02M 55/00
USPC 239/142

(57) ABSTRACT

A fuel injection valve includes: a nozzle body having an injection aperture in a tip portion thereof; a needle that is slidably located in the nozzle body, forms a fuel introduction path between the needle and the nozzle body, and is seated on a seat portion in the nozzle body; a swirling flow generation portion that is located more upstream than the seat portion, and imparts a swirl with respect to a sliding direction of the needle to fuel introduced from the fuel introduction path; and a swirl velocity increasing portion that is located more downstream than the seat portion, and supplies fuel to the injection aperture while producing an air plume by increasing a swirl velocity of a swirling flow generated in the swirling flow generation portion.

### TECHNICAL FIELD

The present invention relates to a fuel injection valve.

### BACKGROUND ART

In recent years, to reduce CO₂ and emissions, there has been an increase in research relating to internal-combustion engines into supercharged lean, a large amount EGR, and premixed self-ignition combustion. According to the research, a stable combustion state near the combustion limit is required in order to reduce CO₂ and emissions most effectively. In addition, while petroleum-based fuel dwindles, the robustness that allows stable combustion even with various fuel such as biofuel is required. The most important point to achieve such stable combustion is to reduce variations in ignition timing of an air-fuel mixture and smooth combustion that burns out the fuel during an expansion stroke.

In addition, an in-cylinder injection system that directly injects fuel into a combustion chamber is employed for a fuel supply in internal-combustion engines to improve transient responsiveness, improve volumetric efficiency by a latent heat of vaporization, and achieve significantly-retarded combustion for catalyst activation at low temperature. However, adoption of the in-cylinder injection system promotes combustion fluctuation due to oil dilution caused by crash of sprayed fuel against a combustion chamber wall with remaining droplet and degradation in fuel atomization due to deposits produced around an injection aperture of an injection valve by liquid fuel.

To prevent such oil dilution and degradation in fuel atomization caused by adoption of the in-cylinder injection system and reduce variations in ignition timing to achieve stable combustion, it is important to atomize fuel spray so that the fuel in the combustion chamber smoothly vaporizes.

As a method of atomizing the fuel spray injected from a fuel injection valve, there has been known a method using a shear force of a thinned liquid film or cavitation occurring by separation of a flow, or atomizing fuel adhering to a surface by mechanical vibration of ultrasonic waves.

Patent Document 1 discloses a fuel injection nozzle that causes the fuel passing through a spiral passage formed between a wall surface of a hollow hole in a nozzle body and a sliding surface of a needle valve to be a rotating flow in a fuel basin that is a circular chamber. This fuel injection nozzle injects the fuel rotating in the fuel basin from a single injection aperture that is located downstream of the fuel basin and has a divergent tapered surface. The injected fuel is dispersed, and mixing with air is promoted.

Patent Document 2 discloses a fuel injection valve that injects fuel mixed with air bubbles generated by a difference between pressures in an air bubble generating passage and an air bubble retaining passage, and atomizes the fuel by collapse energy of air bubbles in the fuel after the injection.

As described above, various approaches have been suggested for fuel injection nozzles and fuel injection valves.

### PRIOR ART DOCUMENT

### Patent Document

[Patent Document 1] Japanese Patent Application Publication No. 10-141183
[Patent Document 2] Japanese Patent Application Publication No. 2006-177174

### SUMMARY OF THE INVENTION

### Problems to be Solved by the Invention

However, the fuel injection nozzle disclosed in Patent Document 1 can disperse fuel spray, but does not consider the atomization of fuel by generating air bubbles in the fuel. Moreover, the fuel injection valve disclosed in Patent Document 2 configures a seat portion to be located more downstream than the air bubble retaining passage. Thus, the fuel temporarily reserved in the air bubble retaining passage is injected at the beginning of the injection. The ratio of air bubbles in the fuel reserved in the air bubble retaining passage in a closed state of the valve is low, and thus atomization at the beginning of the injection is difficult, and the fuel may crash against a cylinder wall remaining in a liquid form. The crash of the fuel in a liquid form against the cylinder wall causes oil dilution.

Thus, the present invention aims to atomize fuel by maintaining air bubbles at the time of fuel injection from an injection aperture and collapsing the air bubbles after the injection.

### Means for Solving the Problems

To solve the above described problems, a fuel injection valve disclosed in the present specification is characterized by including: a nozzle body having an injection aperture in a tip portion thereof; a needle that is slidably located in the nozzle body, forms a fuel introduction path between the needle and the nozzle body, and is seated on a seat portion in the nozzle body; a swirling flow generation portion that is located more upstream than the seat portion, and imparts a swirl with respect to a sliding direction of the needle to fuel introduced from the fuel introduction path; and a swirl velocity increasing portion that is located more downstream than the seat portion, and supplies fuel to the injection aperture while increasing a swirl velocity of a swirling flow generated in the swirling flow generation portion.

An air plume can be produced at a central portion of the swirling flow by increasing the swirl velocity of the swirling flow of fuel. Fine air bubbles are generated at a boundary between the produced air plume and the fuel. Generated fine air bubbles are injected from the injection aperture, and then burst and collapse to atomize sprayed fuel. The sprayed fuel can be atomized as described above.

The fuel injection valve is mounted on an engine so that a tip thereof is exposed to the inside of the combustion chamber. Thus, the injection aperture opens in the combustion chamber. Therefore, burnt gas in the combustion chamber flows into the injection aperture from the injection aperture, and the air plume can be produced in the injection aperture. As described above, the air plume is produced near the opening portion of the injection aperture, and thereby fine air bubbles are generated in the fuel injection valve. This avoids the necessity of preparing an extra device for generating fine air bubbles.

The swirl velocity increasing portion is formed so that an inner diameter thereof decreases toward a most narrowed part located more downstream than the seat portion. The swirl velocity can be accelerated and increased by narrowing a swirl radius of the swirling flow generated in the swirling flow generation portion. The increased swirl velocity can stabilize the swirl of the swirling flow, and thus fluctuation in spray is reduced and a stable injection becomes possible. The most narrowed part may be an opening portion of the injection aperture.

The injection aperture may be located in a position facing the needle, and the needle may have an air reserve chamber facing the injection aperture in a tip portion at a combustion chamber side. Provision of the air reserve chamber allows to combine air (gas) in the air reserve chamber with gas inhaled from the combustion chamber by the swirling flow. This can grow the air plume, and an area of the boundary between the gas and the fuel increases and a generation amount of fine air bubbles increases. Therefore, atomization of the fuel spray is promoted.

The needle may include a porous member in a tip portion at a combustion chamber side, and the porous member may have an opening portion extending toward the injection aperture and facing the injection aperture. Passage of gas in the combustion chamber through the porous member allows to supply fine gas to the fuel. This allows to generate fine air bubbles and atomize fuel even when a fuel pressure is low and the swirl velocity is difficult to increase.

An outside diameter of a tip portion at a combustion chamber side of the porous member may decrease toward a tip. The effect that the injected fuel concentrates in a center of the injection aperture along its shape (the Coanda effect) can be obtained by decreasing the outside diameter by configuring the shape of the tip portion at the combustion chamber side to have a tapered shape or R-curved shape. Therefore, the spray angle can be reduced. To form fine spray, increasing the swirl velocity of the swirling flow is effective. However, on the other hand, as the centrifugal force increases with the increase of the swirl velocity, the spray angle also increases. Thus, even when the shape of the injection aperture is straight, the spray angle may increase depending on a swirling state of fuel. In some cases depending on the type of the engine to which the fuel injection valve is mounted, a modest spray angle is favorable. In such a case, effective is decreasing the outside diameter of the tip portion at the combustion chamber side of the porous member toward the tip. This allows to atomize the spray and suppress the widening of the spray angle.

The nozzle body may be shaped in such a manner that a periphery in which the injection aperture opens is protruded toward a combustion chamber side. When the shape of the tip of the nozzle body in which the injection aperture opens widens toward a lateral direction from the opening portion of the injection aperture in a plane manner, the fuel injected from the injection aperture spreads toward the lateral direction creeping along the shape of the tip of the nozzle body by the Coanda effect. Thus, the spray angle may widen. The present fuel injection valve promotes atomization of fuel by increasing the swirl velocity of fuel. When the swirl velocity of fuel increases, the centrifugal force increases and the spray angle widens. Thus, the spray angle may become larger than required. The Coanda effect can be suppressed, and thus the widening of the spray angle can be suppressed by protruding the periphery in which the injection aperture of the nozzle body opens toward the combustion chamber side. This allows to stably homogenize the air-fuel mixture.

The swirling flow generation portion may include a spiral groove, an angle θ of the spiral groove with respect to a direction perpendicular to a sliding direction of the needle may be 0<θ≦49°, a diameter of the most narrowed part may be 7 to 19% of a diameter of the swirling flow generation portion, a ratio of a fuel passage area of the spiral groove to a flow passage area of the most narrowed part may be 0.4 to 1.3. Fine air bubbles injected from the injection aperture are required to collapse (crush) within a given time period after injection. This is for preventing the adherence because fine air bubbles remaining uncrushed adhere to the wall surface of the combustion chamber. Considering the specification of commonly-used vehicle engines, fine air bubbles preferably crush before a period time of 6 milliseconds elapses after the injection. Experiments reveal that the above condition can cause fine air bubbles to crush within a supposed time period.

### Effects of the Invention

A fuel injection valve disclosed in the present specification can produce an air plume at a center portion of a swirling flow and generate fine air bubbles by increasing a velocity of the swirling flow of fuel. Fine air bubbles are injected from an injection aperture, and then crush and burst to atomize sprayed fuel.

### BRIEF DESCRIPTION OF THE DRAWINGS

FIG. 1 is an explanatory diagram illustrating a configuration of an engine system on which a fuel injection valve in accordance with an embodiment is mounted;

FIG. 2 is an explanatory diagram illustrating a cross section of a main part of the fuel injection valve of the embodiment;

FIG. 3 is an explanatory diagram illustrating a tip portion of the fuel injection valve of the embodiment, FIG. 3A illustrates an opened state of the valve, and FIG. 3B illustrates a closed state of the valve;

FIG. 4 is an explanatory diagram illustrating an air plume produced in the fuel injection valve;

FIG. 5 is an explanatory diagram schematically illustrating how the air plume is produced in the fuel injection valve;

FIG. 6 is a graph illustrating a relationship between a whirl frequency of fuel and a diameter of an air bubble and a time to crush;

FIG. 7 is an explanatory diagram illustrating a tip portion of another fuel injection valve;

FIG. 8 is an explanatory diagram illustrating a tip portion of another fuel injection valve;

FIG. 9 is an explanatory diagram illustrating a tip portion of another fuel injection valve;

FIG. 10 is an explanatory diagram illustrating an air plume produced in the fuel injection valve;

FIG. 11 is an explanatory diagram illustrating a tip portion of another fuel injection valve;

FIG. 12 is an explanatory diagram schematically illustrating an inside of the fuel injection valve illustrated in FIG. 11;

FIG. 13 is an explanatory diagram illustrating a tip portion of another fuel injection valve;

FIG. 14 is an explanatory diagram illustrating a tip portion of another fuel injection valve;

FIG. 15 is an explanatory diagram illustrating a tip portion of another fuel injection valve;

FIG. 16 is an explanatory diagram illustrating dimensions of portions of the fuel injection valve;

FIG. 17 is a graph illustrating a relationship between an angle of a spiral groove and a time to crush of an air bubble;

FIG. 18 is a graph illustrating a relationship between a ratio of a diameter of a most narrowed part to a time to crush of an air bubble;

FIG. 19 is a graph illustrating a relationship between a ratio of an area of a spiral groove to an area of a most narrowed part and a time to crush of an air bubble; and

FIG. 20 is an explanatory diagram illustrating a tip portion of another fuel injection valve.

### MODES FOR CARRYING OUT THE INVENTION

Hereinafter, a description will be given of embodiments of the present invention with reference to drawings. However, in the drawings, dimensions of each portion, ratios, and the like may fail to be illustrated so as to correspond to actual ones. Moreover, in some drawings, detail illustration is omitted.

### First Embodiment

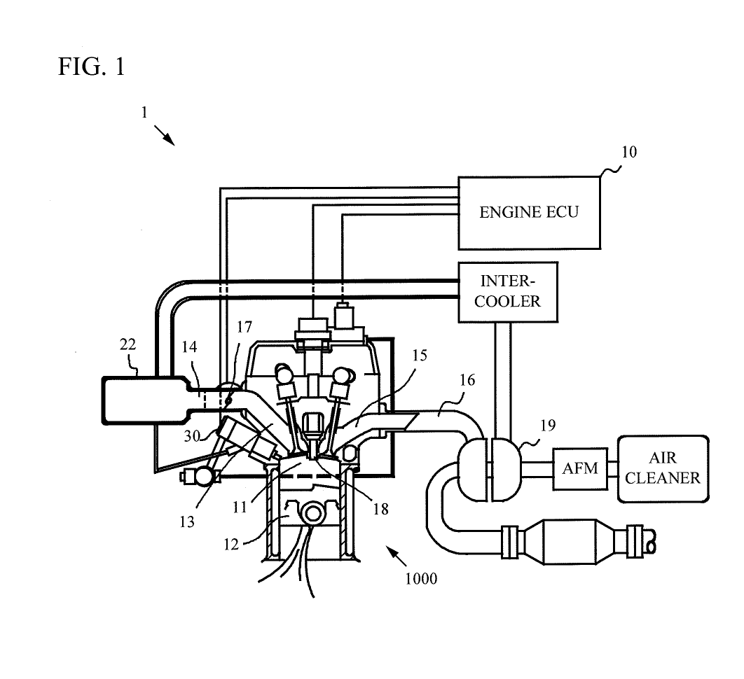

A description will now be given of a first embodiment of the present invention with reference to drawings. FIG. 1 is a diagram illustrating a configuration of an engine system 1 to which a fuel injection valve 30 of the present invention is installed. FIG. 1 illustrates only a part of the components of an engine 1000.

The engine system 1 illustrated in FIG. 1 includes an engine 1000 that is a power source, and an engine ECU (Electronic Control Unit) 10 that overall controls operation of the engine 1000. The engine system 1 includes fuel injection valves 30 that inject fuel into combustion chambers 11 of the engine 1000. The engine ECU 10 has a function as a controller. The engine ECU 10 is a computer including a CPU (Central Processing Unit) that performs arithmetic processing, a ROM (Read Only Memory) that stores programs and the like, and a RAM (Random Access Memory) or NVRAM (Non Volatile RAM) that stores data and the like.

The engine 1000 is an engine mounted on a vehicle, and includes pistons 12 constituting the combustion chambers 11. The pistons 12 are slidably fitted into cylinders of the engine 1000. The pistons 12 are connected to a crankshaft, which is an output shaft member, via connecting rods.

Intake air coming from an intake port 13 into the combustion chamber 11 is compressed in the combustion chamber 11 by upward motion of the piston 12. The engine ECU 10 determines a fuel injection timing based on a position of the piston 12 from a crank angle sensor and information about a camshaft rotational phase from an intake cam angle sensor, and transmits a signal to the fuel injection valve 30. The fuel injection valve 30 injects fuel at the instructed injection timing according to the signal from the engine ECU 10. The fuel injected from the fuel injection valve 30 is atomized and mixed with the compressed intake air. The fuel mixed with the intake air is then ignited by a spark plug 18 to combust, expands the combustion chamber 11, and lowers the piston 12. This downward motion is converted into the rotation of the crankshaft via the connecting rod to power the engine 1000.

Connected to each of the combustion chamber 11 are the intake port 13 communicating with the combustion chamber 11, and an intake passage 14 connected to the intake port 13 and introducing the intake air from the intake port 13 into the combustion chamber 11. Further, connected to the combustion chamber 11 of each cylinder are an exhaust port 15 communicating with the combustion chamber 11, and an exhaust passage 16 guiding the exhaust gas generated in the combustion chamber to the outside of the engine 1000. A surge tank 22 is located in the intake passage 14.

An air flow meter, a throttle valve 17, and a throttle position sensor are located in the intake passage 14. The air flow meter and the throttle position sensor detect a quantity of the intake air passing through the intake passage 14 and an opening degree of the throttle valve 17 respectively, and transmit detection results to the engine ECU 10. The engine ECU 10 recognizes the quantity of the intake air introduced to the intake port 13 and the combustion chamber 11 based on the transmitted detection results, and controls the opening degree of the throttle valve 17 to adjust the intake air quantity.

A turbocharger 19 is located in the exhaust passage 16. The turbocharger 19 rotates a turbine using kinetic energy of the exhaust gas flowing through the exhaust passage 16, and compresses the intake air that has passed through an air cleaner, and pumps it to an intercooler. The compressed intake air is cooled in the intercooler, and then temporarily reserved in the surge tank 22 before introduced into the intake passage 14. In this case, the engine 1000 is not limited to an engine with a supercharger that includes the turbocharger 19, and may be a natural aspiration engine.

The piston 12 has a cavity at the top thereof. The cavity has a wall surface formed so as to continuously smoothly curve from a direction of the fuel injection valve 30 to a direction of the spark plug 18, and guides the fuel injected from the fuel injection valve 30 to near the spark plug 18 along the shape of the wall surface. In this case, the piston 12 may have a cavity formed at an arbitrary position so as to have an arbitrary shape in accordance with the specification of the engine 1000 as a piston of a re-entrant type combustion chamber has a toric cavity formed in the center portion of the top thereof.

The fuel injection valve 30 is mounted on to the combustion chamber 11 located below the intake port 13. The fuel injection valve 30 directly injects fuel, which is supplied at a high pressure from a fuel pump through a fuel passage, from an injection aperture 33 located in a tip portion of a nozzle body 31 into the combustion chamber 11 based on the instruction from the engine ECU 10. The injected fuel is atomized in the combustion chamber 11, and introduced to near the spark plug 18 along the shape of the cavity while being mixed with the intake air. Leak fuel of the fuel injection valve 30 is returned to a fuel tank from a relief valve through a relief pipe.

The fuel injection valve 30 can be located, not limited to below the intake port 13, in an arbitrary position in the combustion chamber 11. For example, it may be located so as to inject fuel from above the center of the combustion chamber 11.

The engine 1000 may be any one of a gasoline engine fueled by gasoline, a diesel engine fueled by light oil, and a flexible fuel engine using fuel formed by mixing gasoline and alcohol at an arbitrary ratio. Moreover, it may be an engine using any fuel that can be injected by the fuel injection valve. The engine system 1 may be a hybrid system combining the engine 1000 and two or more electric motors.

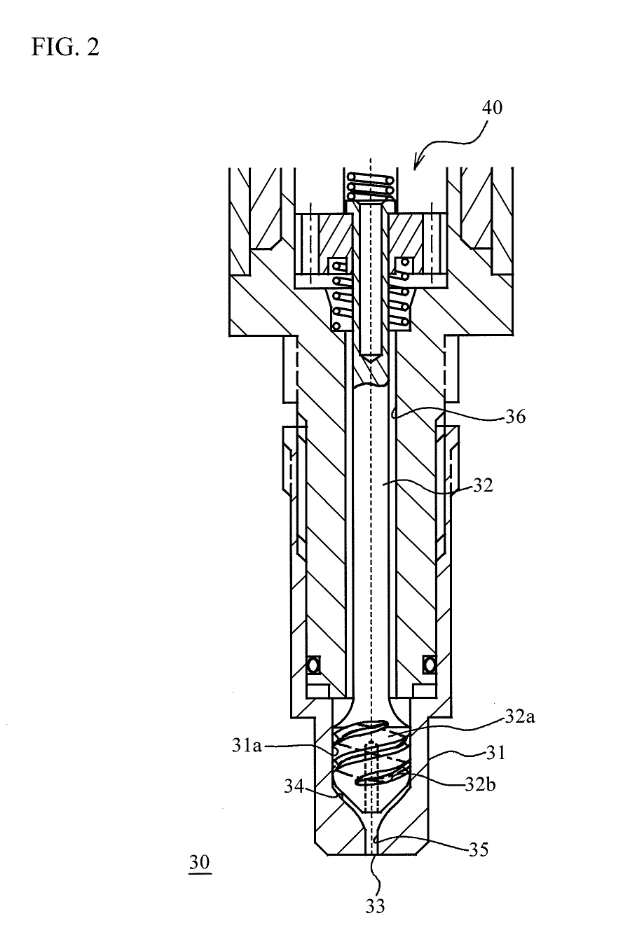

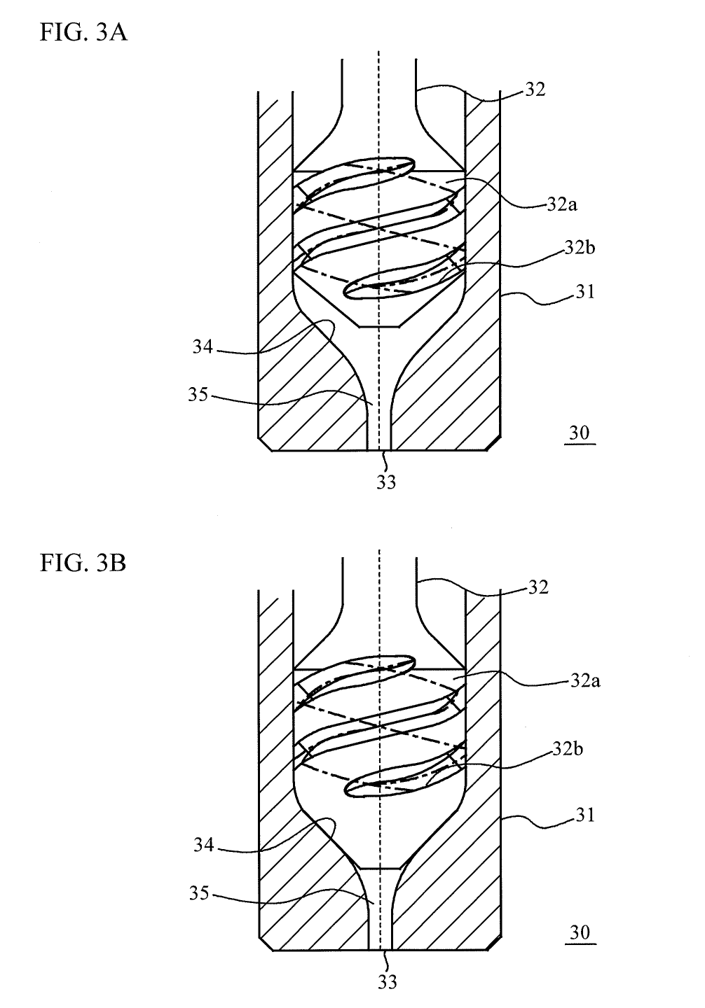

A detail description will next be given of an internal configuration of the fuel injection valve 30 of the embodiment of the present invention. FIG. 2 is an explanatory diagram illustrating a cross-section of a main part of the fuel injection valve 30. FIG. 3 is an explanatory diagram illustrating a tip portion of the fuel injection valve of the embodiment, FIG. 3A is a diagram illustrating an opened state of the valve, and FIG. 3B is a diagram illustrating a closed state of the valve. The fuel injection valve 30 includes the nozzle body 31, a needle 32, and a drive mechanism 40. The drive mechanism 40 controls a sliding motion of the needle 32. The drive mechanism 40 is a conventionally-known mechanism including appropriate components to operate the needle 32 such as actuator using a piezoelectric element, an electric magnet, or the like, and an elastic member that applies an appropriate pressure to the needle 32. Hereinafter, a tip side means a downside of the drawings, and a base end side means an upside of the drawings.

The injection aperture 33 is located in the tip portion of the nozzle body 31. The injection aperture 33 is a single injection aperture formed in the tip of the nozzle body 31 in a direction along the axis of the nozzle body 31. A seat portion 34 on which the needle 32 is seated is formed inside the nozzle body 31. The needle 32 is slidably located in the nozzle body 31 to form a fuel introduction path 36 between it and the nozzle body 31, and seated on the seat portion 34 in the nozzle body 31 to cause the fuel injection valve 30 to be in a closed state as illustrated in FIG. 3B. The needle 32 is lifted upward by the drive mechanism 40, and separates from the seat portion 34 to cause an opened state as illustrated in FIG. 3A. The seat portion 34 is located in a position back from the injection aperture 33. Thus, in any of the opened state and the closed state of the needle 32, the injection aperture 33 communicates with the outside. When the fuel injection valve 30 is mounted so as to be exposed to the combustion chamber 11, the injection aperture 33 communicates with the combustion chamber 11.

The fuel injection valve 30 includes a swirling flow generation portion 32a that is located more upstream than the seat portion 34, and imparts a swirl with respect to the sliding direction of the needle to the fuel introduced from the fuel introduction path 36. The swirling flow generation portion 32a is located in the tip portion of the needle 32. The swirling flow generation portion 32a has a greater diameter than that at the base end side of the needle 32. The tip portion of the swirling flow generation portion 32a is seated on the seat portion 34. As described above, the swirling flow generation portion 32a is located more upstream than the seat portion 34 in the opened state and the closed state.

The swirling flow generation portion 32a has a spiral groove 32b. Passage of the fuel introduced from the fuel introduction path 36 through the spiral groove 32b imparts a swirl to the flow of fuel, and generates a swirling flow of fuel fs.

The fuel injection valve 30 includes a swirl velocity increasing portion 35 that is located more downstream than the seat portion 34, and supplies fuel to the injection aperture 33 while increasing a swirl velocity of the swirling flow generated in the swirling flow generation portion 32a. The swirl velocity increasing portion 35 is formed so that an inner diameter decreases toward a most narrowed part located more downstream than the seat portion 34. Here, the most narrowed part corresponds to a position at which the inner diameter is least in a part located more downstream than the seat portion 34. In the present embodiment, the most narrowed part is the injection aperture 33 as illustrated in FIG. 3A and FIG. 3B. The most narrowed part is not limited to an opening portion of the injection aperture 33.

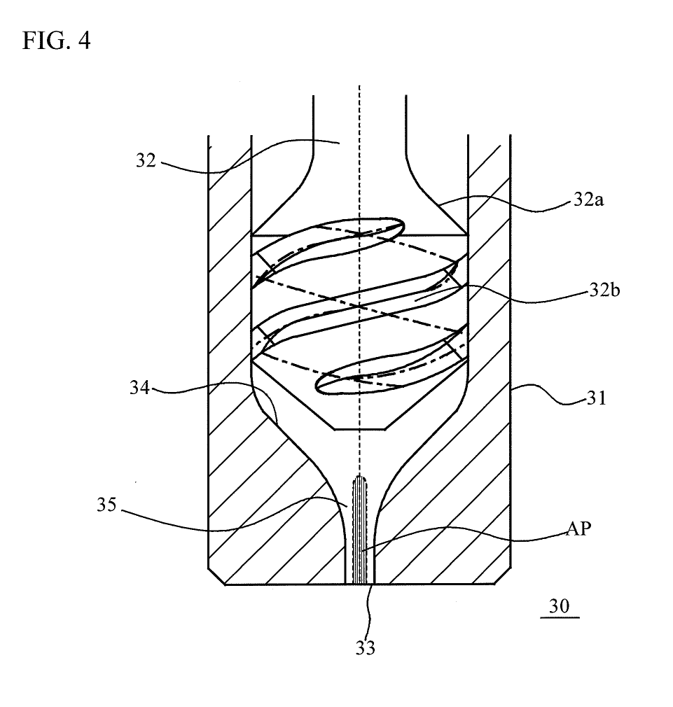

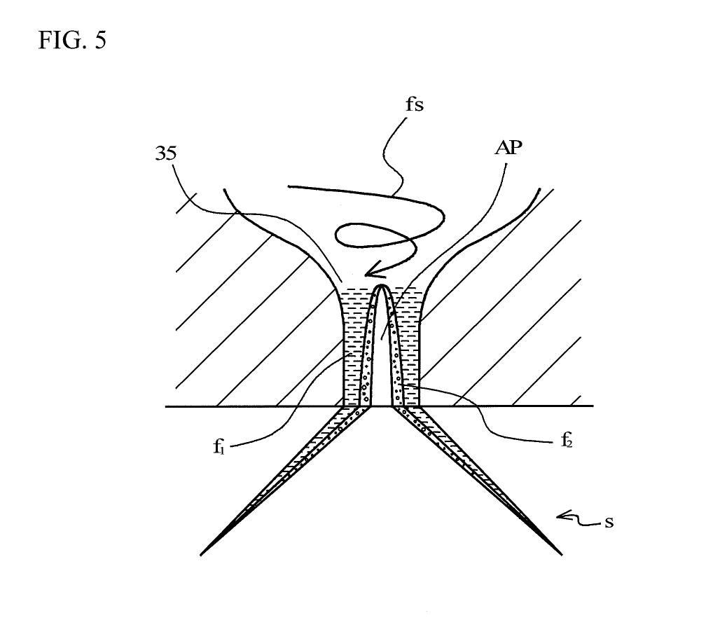

The swirl velocity increasing portion 35 is formed between the seat portion 34 and the injection aperture 33, and accelerates the swirl velocity of the fuel that has passed through the swirling flow generation portion 32a to be in a swirling state. A swirl radius of the swirling flow generated in the swirling flow generation portion 32a is gradually narrowed. The swirling flow fs flows into the narrow region in which the diameter is decreased and increases its swirl velocity. The swirling flow fs with the increased swirl velocity forms an air plume AP in the injection aperture 33 as illustrated in FIG. 4. The inner wall surface of the swirl velocity increasing portion 35 has a raised curved surface toward the center side as illustrated in FIG. 3A and FIG. 3B. Here, a description will be given of formation of the air plume AP and generation of fine air bubbles based on the formation of the air plume AP with reference to FIG. 5.

FIG. 5 is an explanatory diagram illustrating the air plume AP produced in the injection aperture 33. When the swirling flow accelerates in the swirl velocity increasing portion 35, a strong swirling flow fs is formed in the injection aperture 33 through the swirl velocity increasing portion 35, and a negative pressure is generated at the center of the swirl of the strong swirling flow fs. When the negative pressure is generated, air outside the nozzle body 31 is inhaled into the nozzle body 31. This produces the air plume AP in the injection aperture 33. Air bubbles are generated at a boundary face between the produced air plume AP and the fuel. Generated air bubbles are mixed in the fuel flowing around the air plume, and injected as an air bubble containing flow f₂ together with a fuel flow f₁ flowing along an outer periphery side.

At this point, the centrifugal force of the swirling flow forms cone-shaped spray s that disperses from the center in the fuel flow f₁ and the air bubble containing flow f₂. Therefore, a diameter of the cone-shaped spray s increases at greater distances from the injection aperture 33, and thus the sprayed liquid film is extended, and becomes thinner. Then, the liquid film becomes not maintained, and separates. After that, the spray after the separation decreases its diameter by the self-pressurizing effect of fine air bubbles to collapse, and becomes ultrafine atomized spray. As described above, the fuel spray injected from the fuel injection valve 30 is atomized, and thus smooth flame propagation in the combustion chamber is achieved, and stable combustion is performed.

As described above, when vaporization of fuel is promoted by the ultrafine atomization of the fuel spray, PM (Particulate Matter) and HC (hydrocarbon) can be reduced. Moreover, thermal efficiency is also improved. Further, air bubbles are crushed after injected from the fuel injection valve 30, and thus EGR erosion in the fuel injection valve 30 can be suppressed.

When the fuel injection valve 30 is mounted in the combustion chamber 11, gas introduced into the injection aperture 33 is burnt gas after the air-fuel mixture combusts in the combustion chamber 11. As described above, the fuel injection valve in the present embodiment does not need to include an extra structure for introducing gas into the fuel injection valve 30 to form the air plume AP, and thus has a simple structure and also has an advantage in cost.

The fuel injection valve 30 of the present embodiment allows a wide spray angle by the centrifugal force of the swirling flow of fuel. This can promote the mixing with the air. Moreover, since the spray includes air bubbles, i.e. compressible gas, a critical velocity (sonic velocity) at which sound propagates becomes slow. The flow rate of fuel slows as the sonic velocity slows because of physics that the flow rate of fuel cannot exceed the sonic velocity. If the flow rate of fuel slows, penetration decreases, and oil dilution at a bore wall is suppressed. In addition, when the flow rate of fuel slows because of the inclusion of air bubbles, a diameter of the injection aperture is configured to be large to ensure the same fuel injection. Deposits accumulate at the injection aperture. The accumulation of deposits changes an injection quantity. However, if the diameter of the injection aperture is configured to be large, and the injection quantity increases, sensitivity to a change in injection quantity due to the accumulation of deposits (change amount of injection quantity) decreases. That is to say, a ratio of the change amount of injection quantity to the injection quantity decreases, and thus the effect of the change in injection quantity due to the accumulation of deposits becomes smaller.

In addition, the fuel injection valve 30 gradually decreases a swirl radius by the swirl velocity increasing portion 35, and thus the swirling flow fs stabilizes at the injection aperture 33 corresponding to the most narrowed part, and the air plume AP is stably produced. The stable production of the air plume AP reduces variations in air bubble diameter of fine air bubbles generated at the boundary face of the air plume AP. Moreover, fluctuation of fuel injection including fine air bubbles is suppressed. As a result, a particle size distribution of fuel particles formed by the crush of the injected fine air bubbles is reduced, and homogeneous spray can be obtained. In addition, the stable formation of the air plume AP allows to obtain the spray having small variations in particle size of fuel between cycles of the engine 1000. These contribute to a reduction of PM, a reduction of HC, and improvement of thermal efficiency. Further, stable operation with less combustion fluctuation of the engine 1000 becomes possible, and thus fuel efficiency can be improved, toxic exhaust gases can be reduced, EGR (Exhaust Gas Recirculation) can be increased, and an A/F (air-fuel ratio) can be made leaner.

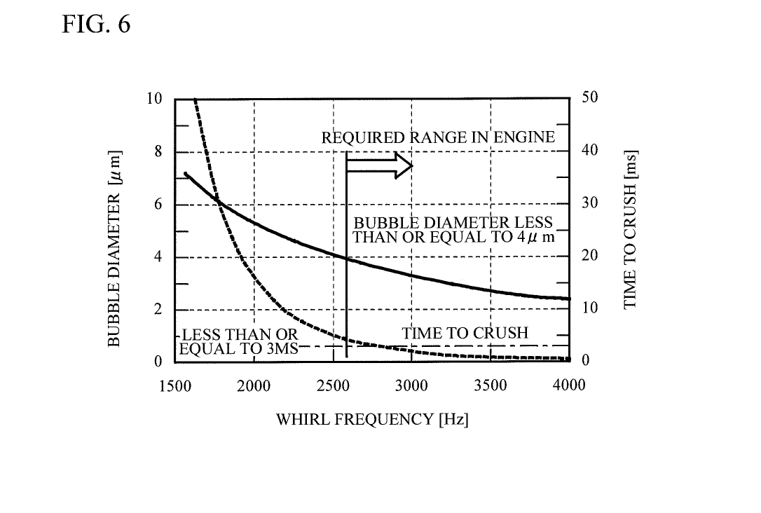

The fuel injection valve of the present embodiment swirls fuel in the swirling flow generation portion 32a and forms the air plume AP to generate fine air bubbles. Here, a whirl frequency of fuel correlates with an air bubble diameter. In addition, an air bubble diameter correlates with a time to crush of air bubbles after fuel injection. Thus, relationships between these elements will be described with reference to FIG. 6.

After injected from the injection aperture 33, the air bubbles preferably crush before reaching a bore wall. If a time that elapses before crush after the injection is required to be less than or equal to 3 ms (3 milliseconds), an air bubble diameter is required to be less than or equal to 4 μm. To achieve the air bubble diameter less than or equal to 4 μm, a whirl frequency is required to be around 2600 Hz. The swirling flow generation portion 32a and the swirl velocity increasing portion 35 are arranged so as to achieve the whirl frequency in accordance with a required time to crush. The fuel injection valve 30 of the present embodiment achieves such a whirl frequency by including the swirl velocity increasing portion 35.

The fuel injection valve 30 of the present embodiment configures central axes of the swirling flow generation portion 32a, the swirl velocity increasing portion 35, and the injection aperture 33 to coincide with each other, but these central axes are not necessary to coincide with each other. It is allowable for the central axes to deviate because of convenience in installation of the fuel injection valve 30 in the engine 1000 or the other requirements.

### Second Embodiment

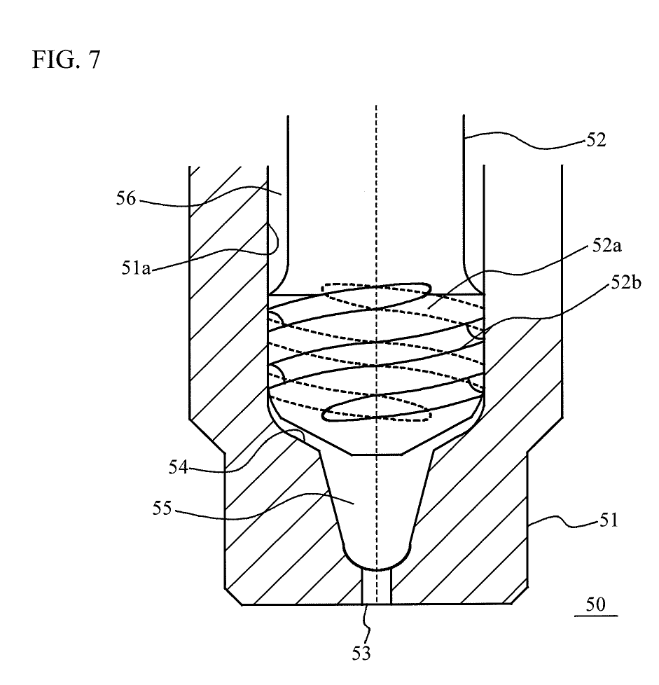

A description will next be given of a second embodiment with reference to FIG. 7. FIG. 7 is an explanatory diagram illustrating a tip portion of a fuel injection valve 50 of the second embodiment. A fundamental configuration of the fuel injection valve 50 is in common with that of the fuel injection valve 30 of the first embodiment. That is to say, the fuel injection valve 50 includes a nozzle body 51, a needle 52, an injection aperture 53, and a seat portion 54. In addition, a fuel introduction path 56 is formed in the fuel injection valve 50. In addition, the fuel injection valve 50 also includes the swirling flow generation portion 52a and the spiral groove 52b as the fuel injection valve 30 does. The fuel injection valve 50 differs from the fuel injection valve 30 in the following respects. That is to say, the shape of the swirl velocity increasing portion 55 differs from that of the swirl velocity increasing portion 35. The inner wall surface of the swirl velocity increasing portion 35 has a raised curved surface toward the central side as illustrated in FIG. 3A and FIG. 3B. In contrast, the swirl velocity increasing portion 55 is bowl-shaped. Even though it is bowl-shaped, the inner diameter decreases toward the most narrowed part (injection aperture 53) located more downstream than the seat portion 54, and thus the swirling flow generated in the swirling flow generation portion 52a can be accelerated. This forms the air plume AP in the same manner as the fuel injection valve 30. In addition, other effects of the fuel injection valve 50 are in common with those achieved by the fuel injection valve 30.

### Third Embodiment

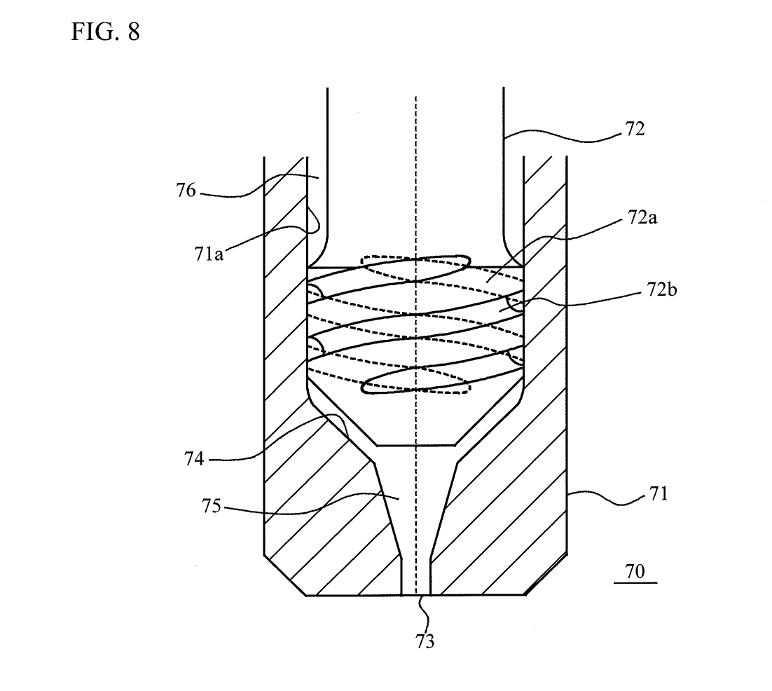

A description will now be given of a third embodiment with reference to FIG. 8. FIG. 8 is an explanatory diagram illustrating a tip portion of a fuel injection valve 70 of the third embodiment. A fundamental configuration of the fuel injection valve 70 is in common with that of the fuel injection valve 30 of the first embodiment. That is to say, the fuel injection valve 70 includes a nozzle body 71, a needle 72, an injection aperture 73, and a seat portion 74. In addition, a fuel introduction path 76 is formed in the fuel injection valve 70. In addition, the fuel injection valve 70 also includes a swirling flow generation portion 72a and a spiral groove 72b as the fuel injection valve 30 does. The fuel injection valve 70 differs from the fuel injection valve 30 in the following respects. That is to say, the shape of the swirl velocity increasing portion 75 differs from that of the swirl velocity increasing portion 35. The inner wall surface of the swirl velocity increasing portion 35 has a raised curved surface toward the central side as illustrated in FIG. 3A and FIG. 3B. In contrast, the swirl velocity increasing portion 75 has a shape similar to a circular cone. Even when it has a shape similar to a circular cone, the inner diameter decreases toward the most narrowed part (injection aperture 73) located more downstream than the seat portion 74, and thus the swirling flow generated in the swirling flow generation portion 72a can be accelerated. This forms the air plume AP in the same manner as the fuel injection valve 30. Further, other effects of the fuel injection valve 70 are in common with those of the fuel injection valve 30.

### Fourth Embodiment

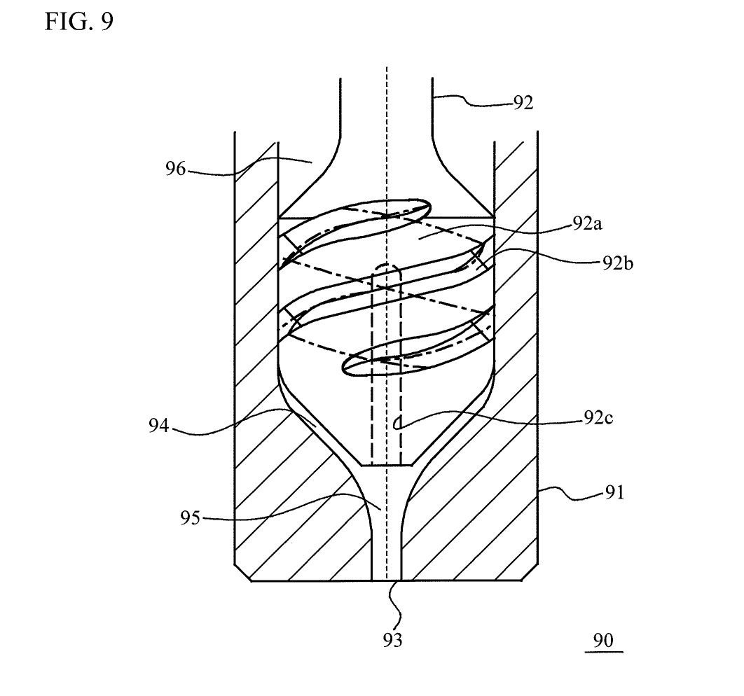

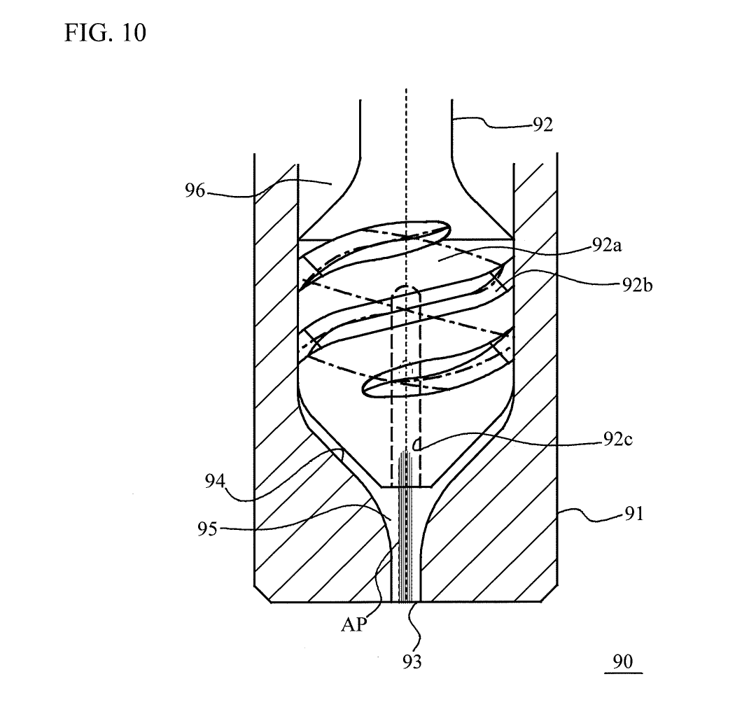

A description will now be given of a fourth embodiment with reference to FIG. 9 and FIG. 10. FIG. 9 is an explanatory diagram illustrating a tip portion of a fuel injection valve 90 of the fourth embodiment. FIG. 10 is an explanatory diagram illustrating the air plume AP produced in the fuel injection valve 90. A fundamental configuration of the fuel injection valve 90 is in common with that of the fuel injection valve 30 of the first embodiment. That is to say, the fuel injection valve 90 includes a nozzle body 91, a needle 92, an injection aperture 93, and a seat portion 94. Moreover, a fuel introduction path 96 is formed in the fuel injection valve 90. The fuel injection valve 90 includes a swirling flow generation portion 92a and a spiral groove 92b as the fuel injection valve 30 does. In addition, a swirl velocity increasing portion 95 is also included. The fuel injection valve 90 differs from the fuel injection valve 30 in the following respects. That is to say, the injection aperture 93 of the fuel injection valve 90 is located in a position facing the needle 92, and the needle 92 has an air reserve chamber 92c facing the injection aperture 93 in the tip portion at a combustion chamber side. The air reserve chamber is a hollow portion located in the needle 92. The air reserve chamber 92c facing the injection aperture 93 allows to achieve the following effects.

As illustrated in FIG. 10, a negative pressure generated by the swirling flow in the injection aperture 93 causes burnt gas inhaled from the outside (combustion chamber side) to coalesce with remaining gas in the air reserve chamber 92c, and the air plume AP is formed. Thus, a length of the air plume AP increases. This increases an area of the boundary face of the air plume AP, and a generation amount of air bubbles increases. The increase in the generation amount of air bubbles increases a density of air bubbles in the spray, and a film pressure of an air bubble by fuel becomes thinner. The thinner film pressure shortens a time to collapse (time to crush). In addition, a particle size of the spray becomes further smaller and homogenized. This prevents liquid fuel from reaching a top portion of the combustion chamber, and thus knocking is suppressed.

Further, the air plume AP is stably formed. This also reduces and homogenizes a spray particle size distribution. As a result, spray having less variations in particle size of fuel between cycles of the engine 1000 can be obtained. These contribute to a reduction of PM, a reduction of HC, and improvement of thermal efficiency. Further, stable operation with less combustion fluctuation of the engine 1000 becomes possible, and thus fuel efficiency can be improved, toxic exhaust gases can be reduced, EGR (Exhaust Gas Recirculation) can be increased, and an A/F (air-fuel ratio) can be made leaner.

In addition, the air reserve chamber 92c, which is a hollow portion, formed in the needle 92 allows to reduce the weight of the needle 92 that is a movable component. The lightened needle 92 can improve the responsiveness of the needle 92. Moreover, an output required of the drive mechanism 40 driving the needle 92 decreases, and thus cost is reduced.

### Fifth Embodiment

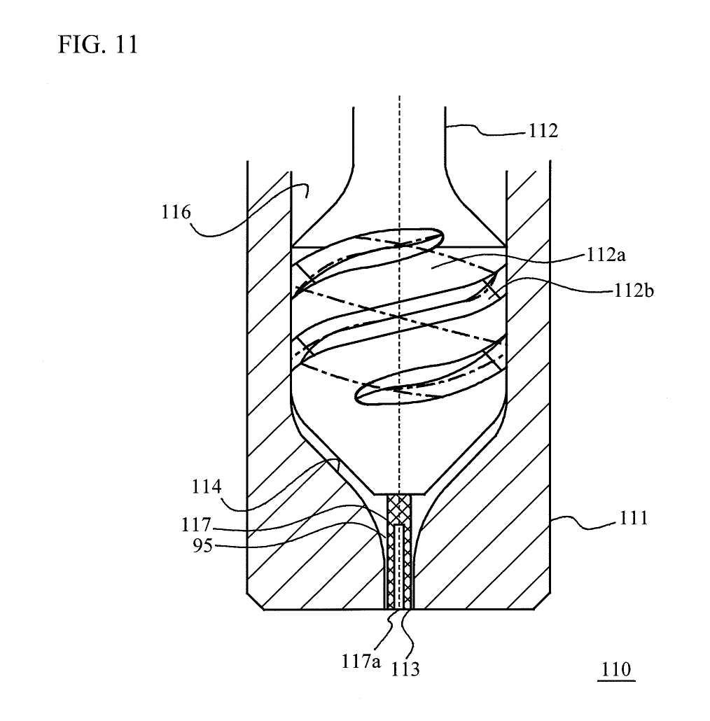

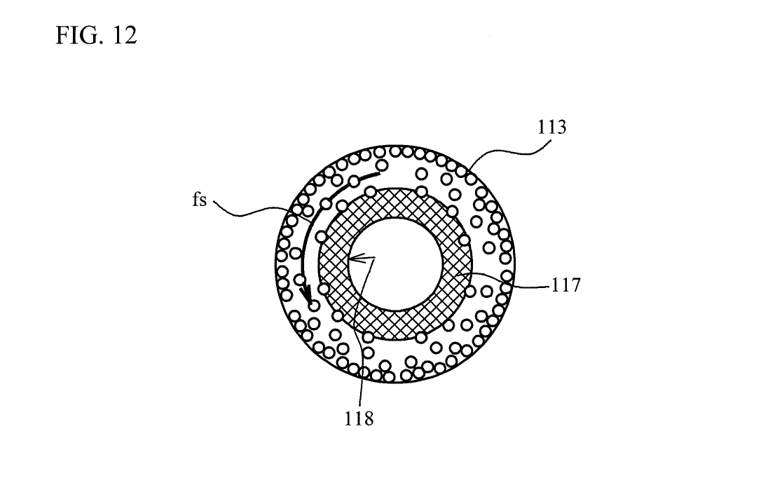

A description will be given of a fifth embodiment with reference to FIG. 11 and FIG. 12. FIG. 11 is an explanatory diagram illustrating a tip portion of a fuel injection valve 110 of the fifth embodiment. FIG. 12 is an explanatory diagram schematically illustrating the inside of the fuel injection valve 110 illustrated in FIG. 11. A fundamental configuration of the fuel injection valve 110 is in common with that of the fuel injection valve 30 of the first embodiment. That is to say, the fuel injection valve 110 includes a nozzle body 111, a needle 112, an injection aperture 113, and a seat portion 114. In addition, a fuel introduction path 116 is formed in the fuel injection valve 110. Moreover, the fuel injection valve 110 includes a swirling flow generation portion 112a and a spiral groove 112b as the fuel injection valve 30 does. In addition, a swirl velocity increasing portion 115 is also included. The fuel injection valve 110 differs from the fuel injection valve 30 in the following respects. That is to say, the needle 112 of the fuel injection valve 110 has a porous member 117 at the tip portion at the combustion chamber side. The porous member 117 includes an opening portion 117a extending toward the injection aperture 113 and facing the injection aperture 113. The porous member 117 moves along a direction of axis of the needle 112 in the swirl velocity increasing portion 115 in accordance with ascent and descent of the needle 112. The porous member 117 may be a cylindrical member that opens at both ends and pierces through its inside, or may be a cylindrical member with a bottom. FIG. 11 illustrates an example of the cylindrical member with a bottom. The needle 112 may have an air reserve chamber as the fifth embodiment has. The porous member 117 may be a cylindrical member that opens at both ends, and the air reserve chamber may be combined thereto. The porous member 117 is adhesively mounted on to the tip portion of the needle 112, but may be mounted by other methods such as press fitting or screw.

Provision of the porous member 117 allows to obtain the following effects. That is to say, as illustrated in FIG. 12, burnt gas introduced into the porous member 117 from the opening portion 117a of the porous member 117 passes through microscopic pores of the porous member 117 as illustrated with an arrow 118, and is supplied to the fuel swirling outside the porous member 117. Thus, even when a fuel pressure is low and the velocity of the swirling flow in the injection aperture 113 decreases, fine air bubbles can be generated, and fine air bubbles can be mixed with the swirling flow.

An outer dimension of the porous member 117 of the fifth embodiment is configured so as to be quarter of a diameter of the injection aperture 113 or greater. This is for the following reason. According to experiments, a ratio of the diameter of the air plume AP to that of the injection aperture is approximately 0.12. Generally, gas passing through microscopic pores from the inside of the porous member 117 immediately combines with gas when gas is present outside the porous member 117. Therefore, air bubbles are not formed. To generate air bubbles, a liquid needs to be present outside of the porous member 117. From this point of view, an outside diameter of the porous member 117 is required to be greater than or equal to the diameter of the air plume AP formed in the injection aperture 113. Therefore, the outside diameter of the porous member 117 of the fifth embodiment is configured to be quarter of the diameter of the injection aperture 113 or greater as the dimension that can satisfy the above described requirement.

Even when fuel is present outside the porous member 117, in a case where the swirl velocity decreases, gasses passing through microscopic pores of the porous member 117 may easily combine with each other. However, it is considered that air bubbles are dispersed into the fuel before gasses combine with each other if the swirling flow is a flow that generates a negative pressure at a swirl center. In addition, ultrafine air bubbles does not deform or unite by crash between air bubbles and mutual interaction with a turbulent airflow as a hard sphere does not. This is confirmed by experiments. Therefore, subject fine air bubbles can be mixed into fuel.

### Sixth Embodiment

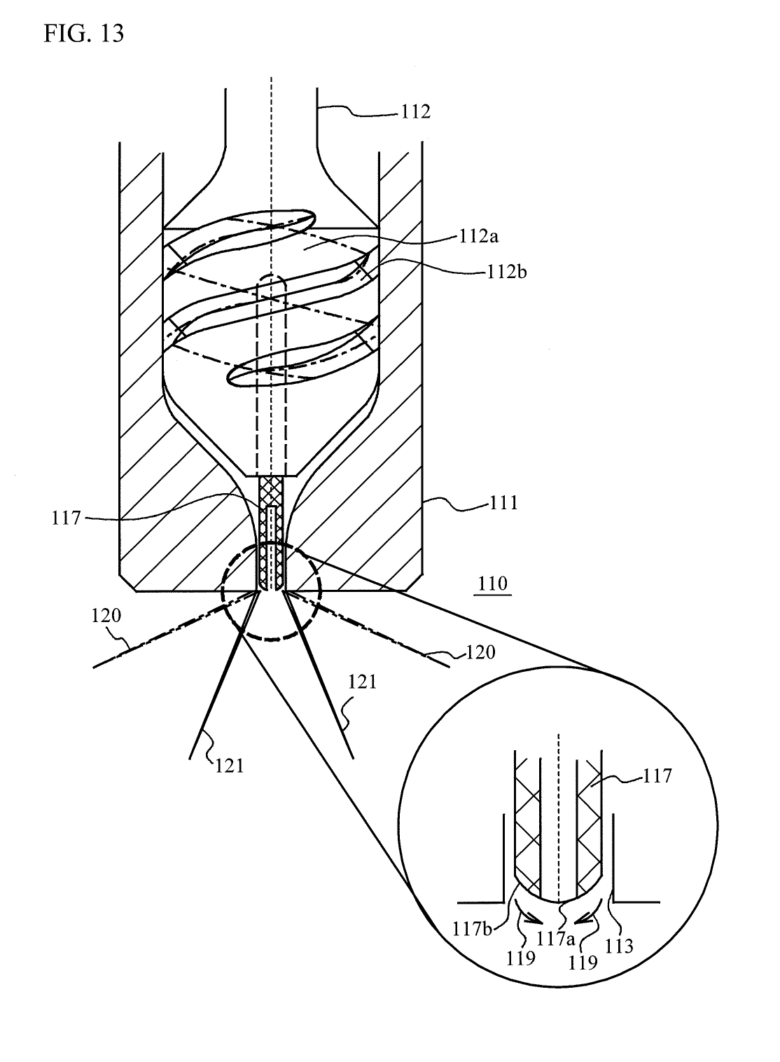

A description will next be given of a sixth embodiment with reference to FIG. 13. FIG. 13 is an explanatory diagram illustrating a tip portion of the fuel injection valve 110 of the sixth embodiment. The sixth embodiment is almost the same as the fifth embodiment. Thus, the same reference numerals are affixed to the identical components in the drawings, and a detail description thereof is omitted. The sixth embodiment differs from the fifth embodiment in the shape of the tip portion of the porous member 117. That is to say, an outside diameter of a tip portion 117b, which is located at the combustion chamber side, of the porous member 117 decreases toward the tip. In other words, it is R-shaped (hemisphere shaped) as enlarged in FIG. 13. The shape of the tip portion 117b at the combustion chamber side may be a tapered shape. The following effects can be obtained by decreasing the outside diameter of the tip portion 117b at the combustion chamber side toward the tip as described above.

The spray angle can be narrowed by flowing fuel along the shape of the tip portion 117b at the combustion chamber side by the Coanda effect as indicated with an arrow 119. As a result, a spray trajectory 120 can be as narrow as a spray trajectory 121.

To form fine spray, increasing the swirl velocity of the swirling flow fs is effective. On the other hand, however, the spray angle increases as the centrifugal force increases with the increase of the swirl velocity. Therefore, even though the shape of the injection aperture is straight, the spray angle may become large depending on the swirling state of fuel. A modest spray angle is sometimes favorable depending on the type of an engine to which the fuel injection valve is installed. In such a case, effective is decreasing the outside diameter of the tip portion 117b at the combustion chamber side of the porous member 117 toward the tip. This configuration can atomize the spray, and prevents the spray angle from widening.

### Seventh Embodiment

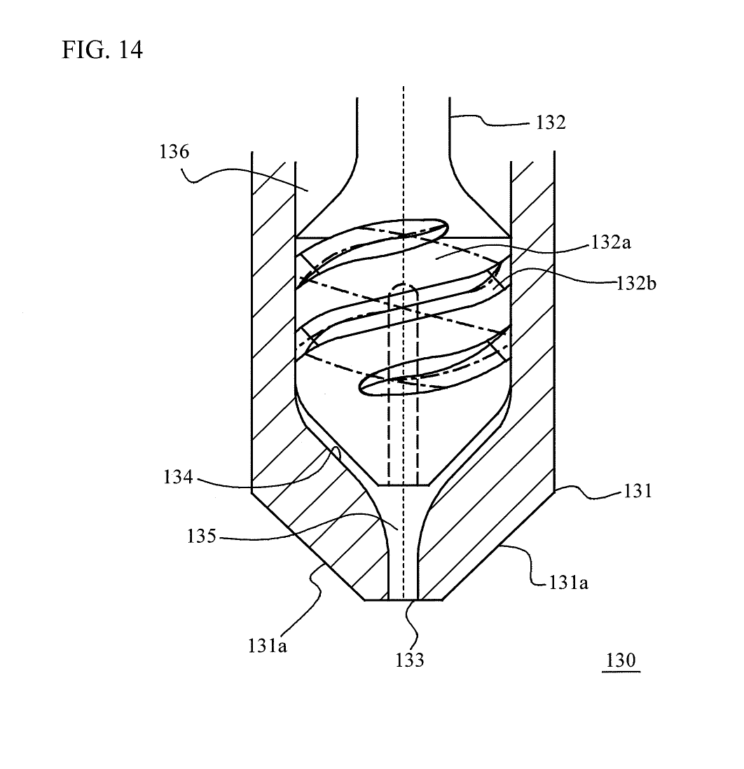

A description will now be given of a seventh embodiment with reference to FIG. 14. FIG. 14 is an explanatory diagram illustrating a tip portion of a fuel injection valve 130 of the seventh embodiment. A fundamental configuration of the fuel injection valve 130 is in common with that of the fuel injection valve 30 of the first embodiment. That is to say, the fuel injection valve 130 includes a nozzle body 131, a needle 132, an injection aperture 133, and a seat portion 134. In addition, a fuel introduction path 136 is formed in the fuel injection valve 130. The fuel injection valve 130 includes a swirling flow generation portion 132a and a spiral groove 132b as the fuel injection valve 30 does. In addition, a swirl velocity increasing portion 135 is also included. The fuel injection valve 130 differs from the fuel injection valve 30 in the following respects. That is to say, the nozzle body 131 of the fuel injection valve 130 is shaped in such a manner that a periphery thereof in which the injection aperture 133 opens protrudes toward the combustion chamber side. More specifically, a tapered surface 131a is formed so that an outside diameter decreases toward the tip of the nozzle body 131.

While fine spray is formed by enhancing the swirling flow, the spray angle widens. Injected spray spreads along the outside wall surface of the nozzle body because of the Coanda effect depending on the shape of the tip portion of the nozzle body. As a result, the spray angle further widens. When the spray angle too widens, the spray spreads creeping along the wall surface of the combustion chamber, and homogenization of an air-fuel mixture may be impaired. Therefore, the periphery of the nozzle body 131 in which the injection aperture 133 opens is protruded to suppress the Coanda effect. This can prevent the spray angle from widening, and stably homogenize the air-fuel mixture.

### Eighth Embodiment

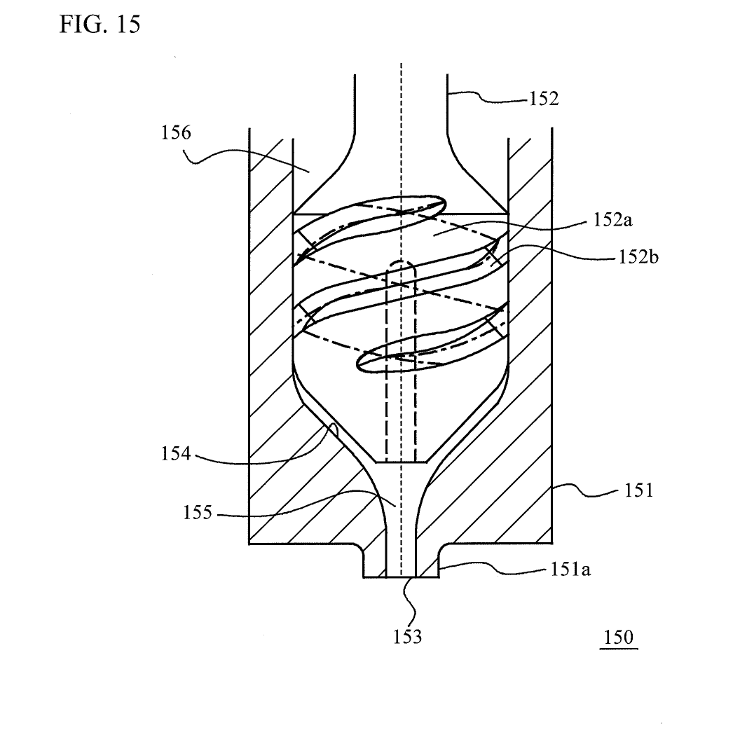

A description will now be given of an eighth embodiment with reference to FIG. 15. FIG. 15 is an explanatory diagram illustrating a tip portion of a fuel injection valve 150 of the eighth embodiment. A fundamental configuration of the fuel injection valve 150 is in common with that of the fuel injection valve 130 of the seventh embodiment. That is to say, the fuel injection valve 150 includes a nozzle body 151, a needle 152, an injection aperture 153, and a seat portion 154. In addition, a fuel introduction path 156 is formed in the fuel injection valve 150. The fuel injection valve 150 includes a swirling flow generation portion 152a and a spiral groove 152b as the fuel injection valve 130 does. Moreover, a swirl velocity increasing portion 155 is also included. Further, the nozzle body 151 of the fuel injection valve 150 is shaped in such a manner that the periphery thereof in which the injection aperture 153 opens protrudes toward the combustion chamber side as that of the fuel injection valve 130 is. However, they differ in a tangible shape. That is to say, the fuel injection valve 130 has the tapered surface 131a of which the outside diameter decreases toward the tip of the nozzle body 131, while the fuel injection valve 150 has a raised portion 151a. The fuel injection valve 150 having the raised portion 151a can suppress the Coanda effect as the fuel injection valve 130 does. As a result, the spray angle can be prevented from widening, and stable homogenization of the air-fuel mixture can be achieved.

### Ninth Embodiment

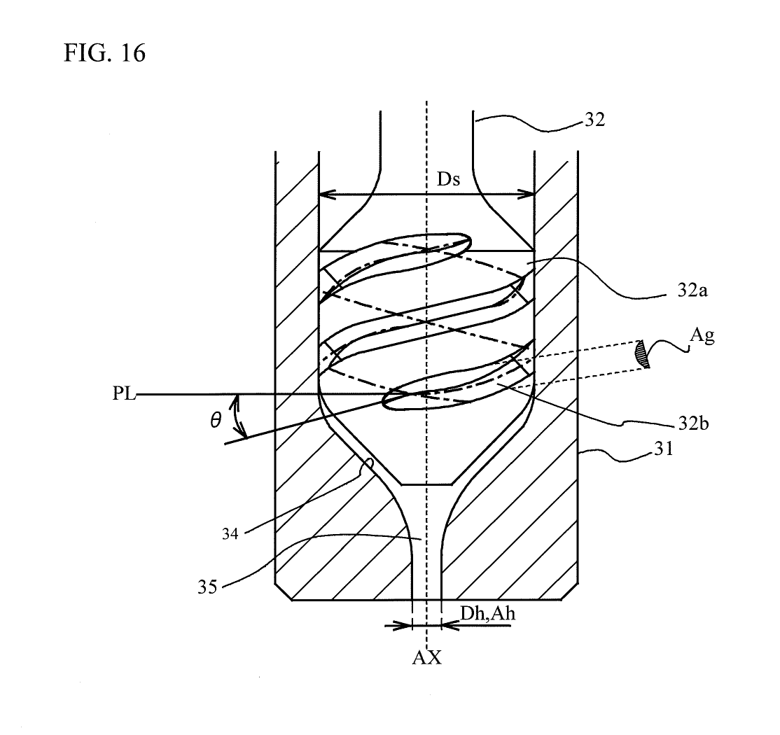

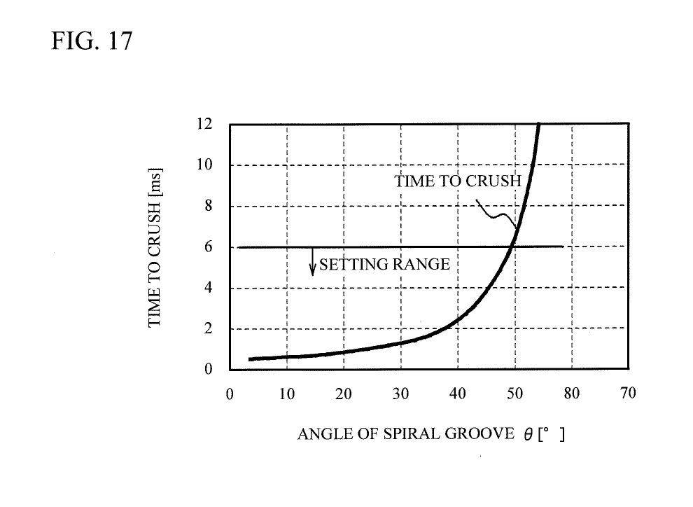

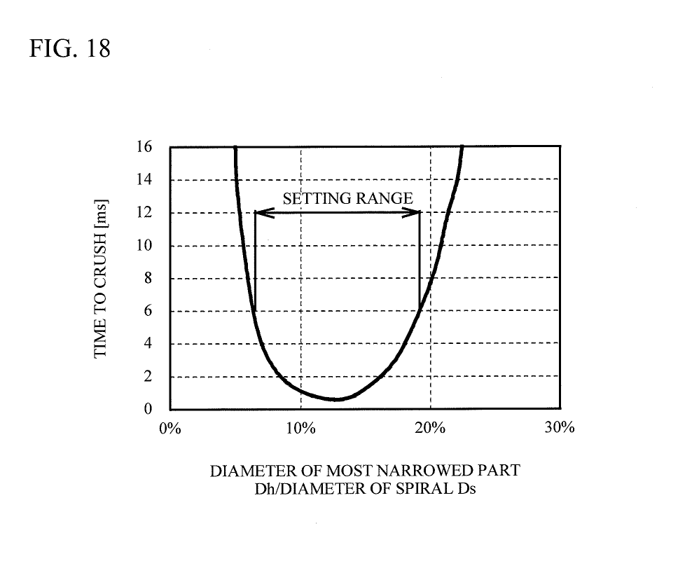

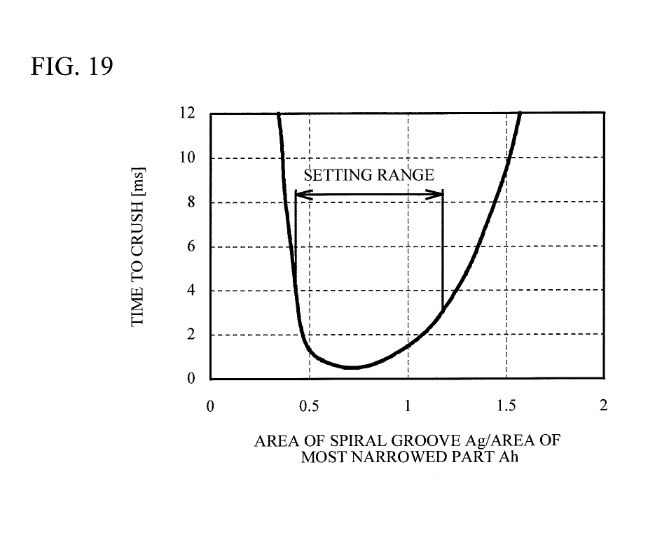

In a ninth embodiment, a description will be given of specifications of components included in the fuel injection valve with reference to FIG. 16 through FIG. 19. FIG. 16 is an explanatory diagram illustrating examples of dimensions of components in the fuel injection valve 30. FIG. 17 illustrates a graph presenting a relationship between an angle of a spiral groove θ and a time to crush of air bubbles. FIG. 18 illustrates a graph presenting a relationship between a ratio of a diameter of the most narrowed part Dh to a diameter of a spiral Ds and a time to crush of air bubbles. FIG. 19 illustrates a graph presenting a relationship between a ratio of an area of a spiral groove Ag to a flow passage area Ah of the most narrowed part and a time to crush of air bubbles. In the present embodiment, the specification of each component is described using the fuel injection valve 30 described in the first embodiment, but the same specification can be applied to other embodiments.

Here, the specifications are determined on the grounds that the engine 1000 is a vehicle engine and a bore diameter of a commonly-used vehicle engine is less than or equal to 180 mm. In addition, the specifications are determined so that the fine air bubbles injected from the injection aperture 33 of the fuel injection valve 30 installed at the center of the combustion chamber crush before reaching the bore wall. When the bore diameter is 180 mm, it takes 6 ms till the injected spray reaches the bore wall, and thus fine air bubbles are required to crush within less than or equal to 6 ms after injected from the injection aperture 33. The specifications are determined in consideration of the above requirement. Each specification has a certain range, and may be arbitrarily changed in accordance with the specification of the engine 1000. For example, when the bore diameter is 90 mm, a time that elapses before reaching the bore wall becomes 3 ms, and each specification is determined so that a time to crush becomes less than or equal to 3 ms. A time that elapses before reaching the bore wall is calculated under the assumption that a fuel pressure is 2 MPa, an initial spray speed is approximately 45 m/s, and an average spray speed is approximately 15 m/s.

### <<Angle of a Swirl Groove θ>>

A description will first be given of a range of an angle of a swirl groove θ. The swirling flow generation portion 32a includes the spiral groove 32b. Here, an angle of the spiral groove 32b with respect to a direction PL perpendicular to the sliding direction of the needle 32 (central axis AX direction) is represented with an angle of a spiral groove θ. With reference to FIG. 17, the angle of an spiral groove θ at which the time to crush is 6 ms is 0<θ≦49°. If the time to crush is desired to be less than or equal to 3 ms, the angle may be configured to be approximately to 0<θ≦42°.

### <<Ratio of a Diameter of a Most Narrowed Part Dh to a Diameter of a Spiral Ds>>

In the fuel injection valve 30 of the embodiment, the diameter of the most narrowed part Dh corresponds to the diameter of the injection aperture. The diameter of the spiral Ds corresponds to the diameter of the swirling flow generation portion 32a. With reference to FIG. 18, the ratio of the diameter of the most narrowed part Dh to the diameter of the spiral Ds at which the time to crush is 6 ms is 7 to 19%.

The swirling flow flows in the injection aperture 33 from the spiral groove 32b while increasing its velocity at a ratio of 1/(Dh/Ds)². This generates a negative pressure at a center portion of the swirl, inhales burnt gas in the combustion chamber, and produces an air plume.

### <<Ratio of an Area of the Spiral Groove Ag to a Flow Passage Area of the Most Narrowed Part Ah>>

The area of the spiral groove Ag is a fuel passage area of the spiral groove 32b as illustrated in FIG. 16. The flow passage area of the most narrowed part Ah is a flow passage area of the injection aperture 33. With reference to FIG. 19, the ratio of an area of the spiral groove Ag to the flow passage area of the most narrowed part Ah at which the time to crush is 6 ms is 0.4 to 1.3.

As described above, the specifications can be determined. Each specification may be set so that the required time to crush is achieved. If the fuel pressure rises, the air bubble diameter decreases, and thus the allowable range of the specification widens.

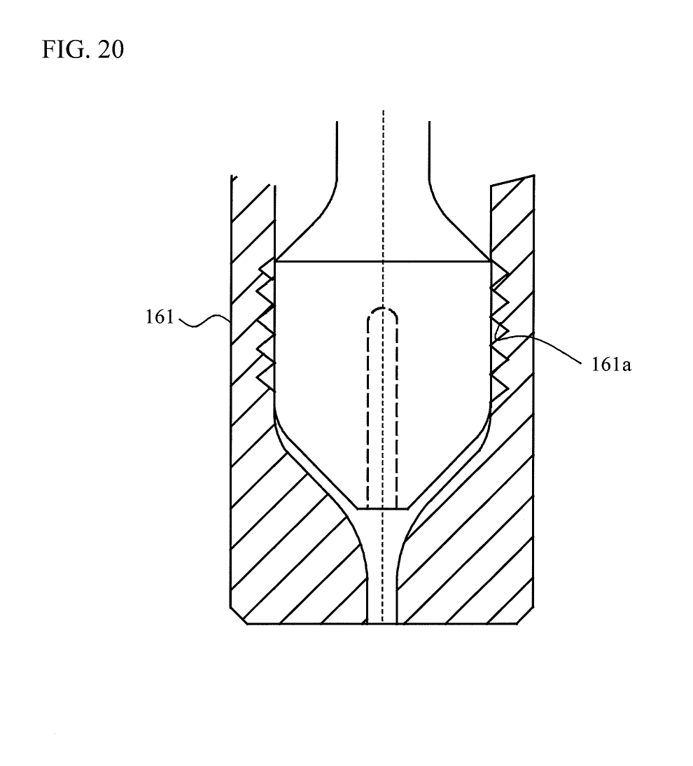

While the exemplary embodiments of the present invention have been illustrated in detail, the present invention is not limited to the above-mentioned embodiments, and other embodiments, variations and modifications may be made without departing from the scope of the present invention. For example, all the above described embodiments have a swirling flow generation portion with a spiral groove in a needle, but a spiral groove 161a may be located on an inner wall of a nozzle body 161 to generate the swirling flow of fuel as illustrated in FIG. 20.

### DESCRIPTION OF LETTERS OR NUMERALS

1 engine system
30, 50, 70, 90, 110, 130, 150 fuel injection valve
31, 51, 71, 91, 111, 131, 151, 161 nozzle body
32, 52, 72, 92, 112, 132 needle
131b tip protruding portion
32a, 52a, 72a, 92a, 112a, 132a swirling flow generation portion
32b, 52b, 72b, 92b, 112b, 132b, 161a spiral groove
92c air reserve chamber
33, 53, 73, 93, 113, 133, 153 injection aperture (most narrowed part)
34, 54, 74, 94, 114, 134, 154 seat portion
35, 55, 75, 95, 115, 135, 155 swirl velocity increasing portion
36, 56, 76, 96, 116, 136, 156 fuel introduction path
117 porous member
117a opening portion
117b tip portion at combustion chamber side
120, 121 spray trajectory
1000 engine
AP air plume
f1 fuel flow
f2 air bubble containing flow
fs swirling flow
θ angle of swirl groove
Ag area of spiral groove
Ds diameter of the spiral
Dh most narrowed diameter (diameter of injection aperture)
Ah flow passage area of most narrowed part (area of injection aperture)

1.-8. (canceled)

9. A fuel injection valve comprising:
a nozzle body having an injection aperture in a tip portion thereof;
a needle that is slidably located in the nozzle body, forms a fuel introduction path between the needle and the nozzle body, and is seated on a seat portion in the nozzle body;
a swirling flow generation portion that is located more upstream than the seat portion, and imparts a swirl with respect to a sliding direction of the needle to fuel introduced from the fuel introduction path; and
a swirl velocity increasing portion that is located more downstream than the seat portion, and supplies fuel to the injection aperture while producing an air plume by increasing a swirl velocity of a swirling flow generated in the swirling flow generation portion.

10. A fuel injection valve comprising:
a nozzle body having an injection aperture in a tip portion thereof;
a needle that is slidably located in the nozzle body, forms a fuel introduction path between the needle and the nozzle body, and is seated on a seat portion in the nozzle body;
a swirling flow generation portion that is located more upstream than the seat portion, and imparts a swirl with respect to a sliding direction of the needle to fuel introduced from the fuel introduction path; and
a swirl velocity increasing portion that is located more downstream than the seat portion, and supplies fuel to the injection aperture while increasing a swirl velocity of a swirling flow generated in the swirling flow generation portion, wherein
the needle includes a porous member in a tip portion at a combustion chamber side, and
the porous member includes an opening portion extending toward the injection aperture and facing the injection aperture.

11. The fuel injection valve according to claim 9, wherein the swirl velocity increasing portion is formed so that an inner diameter thereof decreases toward a most narrowed part located more downstream than the seat portion so that a swirl radius of the swirling flow generated in the swirling flow generation portion is narrowed.

12. The fuel injection valve according to claim 9
the injection aperture is located in a position facing the needle, and
the needle has an air reserve chamber facing the injection aperture in a tip portion at a combustion chamber side.

13. The fuel injection valve according to claim 9,
the needle includes a porous member in a tip portion at a combustion chamber side, and
the porous member includes an opening portion extending toward the injection aperture and facing the injection aperture.

14. The fuel injection valve according to claim 10
an outside diameter of a tip portion at a combustion chamber side of the porous member decreases toward a tip.

15. The fuel injection valve according to claim 9, wherein
a periphery of the nozzle body in which the injection aperture opens is protruded toward a combustion chamber side.

16. The fuel injection valve according to claim 9, wherein
the swirling flow generation portion includes a spiral groove,
an angle θ of the spiral groove with respect to a direction perpendicular to a sliding direction of the needle is 0<θ≦49°,
a diameter of the most narrowed part is 7 to 19% of a diameter of the swirling flow generation portion, and
a ratio of a fuel passage area of the spiral groove to a flow passage area of the most narrowed part is 0.4 to 1.3.

17. The fuel injection valve according to claim 10, wherein the swirl velocity increasing portion is formed so that an inner diameter thereof decreases toward a most narrowed part located more downstream than the seat portion so that a swirl radius of the swirling flow generated in the swirling flow generation portion is narrowed.

18. The fuel injection valve according to claim 10, wherein
the injection aperture is located in a position facing the needle, and
the needle has an air reserve chamber facing the injection aperture in a tip portion at a combustion chamber side.

19. The fuel injection valve according to claim 13, wherein
an outside diameter of a tip portion at a combustion chamber side of the porous member decreases toward a tip.

20. The fuel injection valve according to claim 10, wherein
a periphery of the nozzle body in which the injection aperture opens is protruded toward a combustion chamber side.

21. The fuel injection valve according to claim 10, wherein
the swirling flow generation portion includes a spiral groove,
an angle θ of the spiral groove with respect to a direction perpendicular to a sliding direction of the needle is 0<θ≦49°,
a diameter of the most narrowed part is 7 to 19% of a diameter of the swirling flow generation portion, and
a ratio of a fuel passage area of the spiral groove to a flow passage area of the most narrowed part is 0.4 to 1.3.
